(19) United States
(12) Patent Application Publication
(10) Pub. No.: US 2025/0229177 A1
(43) Pub. Date: Jul. 17, 2025

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Yuki Nishi, Tokyo (JP); Koji Nara, Tokyo (JP); Shintaro Tamura, Tokyo (JP)

(73) Assignee: CYGAMES, INC., Tokyo (JP)

(21) Appl. No.: 19/169,525

(22) Filed: Apr. 3, 2025

Related U.S. Application Data
(63) Continuation of application No. PCT/JP2023/041589, filed on Nov. 20, 2023.

(30) Foreign Application Priority Data
Nov. 25, 2022 (JP) 2022-188115

(51) Int. Cl. A63F 13/525; A63F 13/63

(52) U.S. Cl. CPC A63F 13/525; A63F 13/63

(57) ABSTRACT

A non-transitory computer readable medium stores a program causing a computer to execute processing of receiving an operation from a player for designating any number of two or greater as the number of lotteries for a lottery object; processing of arranging, according to a predetermined arrangement criterion, a plurality of common objects (silhouette character models 424) being are 3D models at lottery result arrangement positions (arrangement spaces 426) in a virtual space VS, based on the number of lotteries designated by the player; and processing of changing an arrangement position of a virtual camera CA arranged in the virtual space VS, based on the number of lotteries designated by the player or the lottery result arrangement positions where the plurality of common objects are arranged.

### CROSS REFERENCE TO RELATED APPLICATIONS

This application is a continuation application of International Application No. PCT/JP2023/041589, filed on Nov. 20, 2023, which claims priority to Japanese Patent Application No. 2022-188115, filed on Nov. 25, 2022, the entire contents of which are incorporated by reference herein.

### BACKGROUND ART

### Technical Field

The present invention relates to an information processing program, an information processing method, and an information processing system.

In the related art, lottery processing is known in which a player can spend an in-game item possessed by the player to obtain a game content used in a game by a lottery. For example, Non-Patent Document 1 discloses that, in such lottery processing, lotteries can be consecutively performed multiple times at one time, and a player can select the number of lotteries to be consecutively performed.

### CITATION LIST

### Patent Literature

Non-Patent Document 1: Online Roboaction RPG “Steel War Chronicles C21” Official site, Info, News, [online], May 27, 2010, [Accessed Nov. 8, 2022], Internet <URL: http://www.C21-online.jp/info/topic/9121>

### SUMMARY OF INVENTION

### Technical Problem

However, in the lottery processing described in Non-Patent Document 1, although the number of lotteries can be any number designated by the player, there is no change in a lottery animation according to the designated number of lotteries and the player's enjoyment is lowered.

An object of the present invention is to provide an information processing program, an information processing method, and an information processing system capable of enhancing the player's enjoyment.

### Solution to Problem

To solve the problem described above, an information processing program causes a computer to execute:
processing of receiving an operation from a player for designating any number of two or greater as the number of lotteries for a lottery object;
processing of arranging, according to a predetermined arrangement criterion, a plurality of common objects being 3D models at lottery result arrangement positions in a virtual space, based on the number of lotteries designated by the player; and
processing of changing an arrangement position of a virtual camera arranged in the virtual space, based on the number of lotteries designated by the player or the lottery result arrangement positions where the plurality of common objects are arranged.

An upper limit is set for the number of lotteries designated by the player,
in the virtual space,
a virtual arrangement frame including a plurality of the lottery result arrangement positions may be provided, and
the plurality of common objects may be arranged at all of the plurality of lottery result arrangement positions in the virtual arrangement frame in a case where the number of lotteries is the upper limit, and
the processing of changing the arrangement position of the virtual camera may include
arranging the virtual camera to be aligned at a center position of the virtual arrangement frame, in a case where the number of lotteries is the upper limit, and
arranging the virtual camera at an offset position offset from the center position based on the number of lotteries or the lottery result arrangement positions where the plurality of common objects are arranged, in a case where the number of lotteries is less than the upper limit.

The processing of changing the arrangement position of the virtual camera may include,
in a case where the number of lotteries is less than the upper limit, arranging the virtual camera to be aligned at the center position of the virtual arrangement frame, and then arranging the virtual camera at the offset position.

The predetermined arrangement criterion may include that
the plurality of common objects arranged in the virtual space is divided into at least a first group and a second group, and the first group and the second group are arranged in a line in a predetermined direction at the lottery result arrangement positions, and
the processing of changing the arrangement position of the virtual camera may include
arranging the virtual camera to be aligned at a center of the first group and a center of the second group.

In order to solve the problem described above, an information processing method executed by one or more computers includes:
processing of receiving an operation from a player for designating any number of two or greater as the number of lotteries for a lottery object;
processing of arranging, according to a predetermined arrangement criterion, a plurality of common objects being 3D models at lottery result arrangement positions in a virtual space, based on the number of lotteries designated by the player; and
processing of changing an arrangement position of a virtual camera arranged in the virtual space, based on the number of lotteries designated by the player or the lottery result arrangement positions where the plurality of common objects are arranged.

To solve the problem described above, an information processing system includes one or more computers, wherein the one or more computers execute:
processing of receiving an operation from a player for designating any number of two or greater as the number of lotteries for a lottery object;
processing of arranging, according to a predetermined arrangement criterion, a plurality of common objects being 3D models at lottery result arrangement positions in a virtual space, based on the number of lotteries designated by the player; and
processing of changing an arrangement position of a virtual camera arranged in the virtual space, based on the number of lotteries designated by the player or the lottery result arrangement positions where the plurality of common objects are arranged.

### Effects of Disclosure

According to the present invention, it is possible to enhance the player's enjoyment.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3 is a diagram for describing an example of a home screen.

FIG. 4A is a diagram illustrating an example of a lottery screen of a nurture game content. FIG. 4B is a diagram illustrating an example of a lottery screen of a support game content.

FIG. 5 is a diagram illustrating an example of a lottery confirmation screen.

FIG. 6 is a diagram illustrating an example of an animation screen of a first phase of a lottery animation.

FIG. 7 is a first diagram illustrating a state in which a 3DCG image is generated in a first phase of a lottery animation.

FIG. 8 is a second diagram illustrating a state in which a 3DCG image is generated in a first phase of a lottery animation.

FIG. 9 is a diagram illustrating an example of an animation screen of a second phase of a lottery animation.

FIG. 10 is a diagram illustrating a state in which a 3DCG image is generated in a second phase of a lottery animation.

FIG. 11 is a diagram illustrating an example of an animation screen of a third phase of a lottery animation.

FIG. 12 is a diagram illustrating a state in which a 3DCG image is generated in a third phase of a lottery animation according to the present embodiment.

FIG. 13 is a diagram illustrating a state in which a 3DCG image is generated in a third phase of a lottery animation according to a first modified example.

FIG. 14 is a diagram illustrating a state in which a 3DCG image is generated in a third phase of a lottery animation according to a second modified example.

FIG. 15 is a diagram illustrating an example of an animation screen of a fourth phase of a lottery animation.

FIG. 16 is a diagram illustrating a state in which a 3DCG image is generated in a fourth phase of a lottery animation.

FIG. 17 is a diagram illustrating an example of an animation screen of a fifth phase of a lottery animation.

FIG. 18 is a diagram illustrating an example of a lottery result screen of a lottery.

FIG. 19 is a diagram illustrating an example of a lottery result screen that changes according to the number of lotteries.

FIG. 20 is a diagram illustrating an example of an animation screen of a lottery animation for a support game content.

FIG. 21 is a diagram for describing a configuration of a memory in a player terminal and a function as a computer.

FIG. 22 is a diagram for describing a configuration of a memory in a server and a function as a computer.

FIG. 23 is a sequence diagram for describing basic processing of a player terminal and a server.

FIG. 24 is a flowchart for describing an example of lottery processing in a server.

FIG. 25 is a flowchart for describing an example of animation screen display processing according to the present embodiment.

FIG. 26 is a flowchart for describing an example of a third phase animation processing according to the present embodiment.

FIG. 27 is a flowchart for describing an example of a third phase animation processing according to the first modified example.

FIG. 28 is a flowchart for describing an example of a third phase animation processing according to the second modified example.

### DESCRIPTION OF EMBODIMENTS

Hereinafter, an aspect of an embodiment of the present invention will be described in detail with reference to the accompanying drawings. Dimensions, materials, specific numerical values, and the like described in the embodiment are merely examples for facilitating understanding and do not limit the present invention unless otherwise specified. In this specification and the drawings, elements having substantially the same function and configuration are denoted by the same reference numerals, and redundant description thereof will be omitted, and elements not directly relating to the present invention will not be illustrated.

### Overall Configuration of Information Processing System S

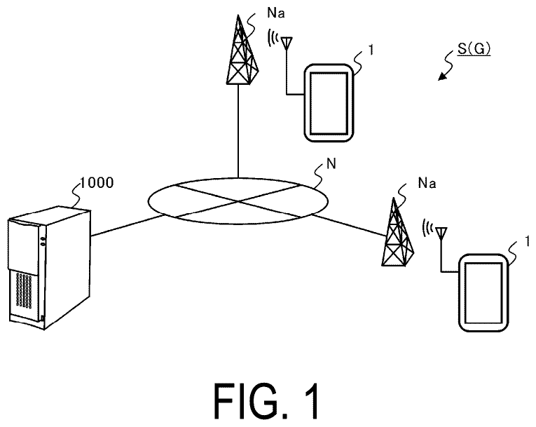

FIG. 1 is an explanatory diagram illustrating a schematic configuration of an information processing system S. The information processing system S is a so-called client-server system including a player terminal 1, a server 1000, and a communication network N including a communication base station Na.

The player terminal 1 can establish communication with the server 1000 via the communication network N. The player terminal 1 widely includes an electronic device capable of establishing a wireless or wired communication connection with the server 1000. Examples of the player terminal 1 include a smartphone, a mobile phone, a tablet device, a personal computer, a game console, and the like. In the present embodiment, a case where a smartphone is used as the player terminal 1 will be described.

The server 1000 is communicatively connected to a plurality of player terminals 1. The server 1000 accumulates various kinds of information (player information) for each player who plays the game. In addition, the server 1000 performs updating of the accumulated information based on an operation input from the player terminal 1.

The communication base station Na is connected to the communication network N and wirelessly exchanges information with the player terminal 1. The communication network N is constituted by a cellular network, an Internet network, a local area network (LAN), a dedicated line, or the like, and establishes a wireless or wired communication connection between the player terminal 1 and the server 1000.

In the information processing system S of the present embodiment, the player terminal 1 and the server 1000 function as a game apparatus G. Each of the player terminal 1 and the server 1000 has a role of controlling the progress of the game, and the game can progress via cooperation between the player terminal 1 and the server 1000.

### Hardware Configuration of Player Terminal 1 and Server 1000

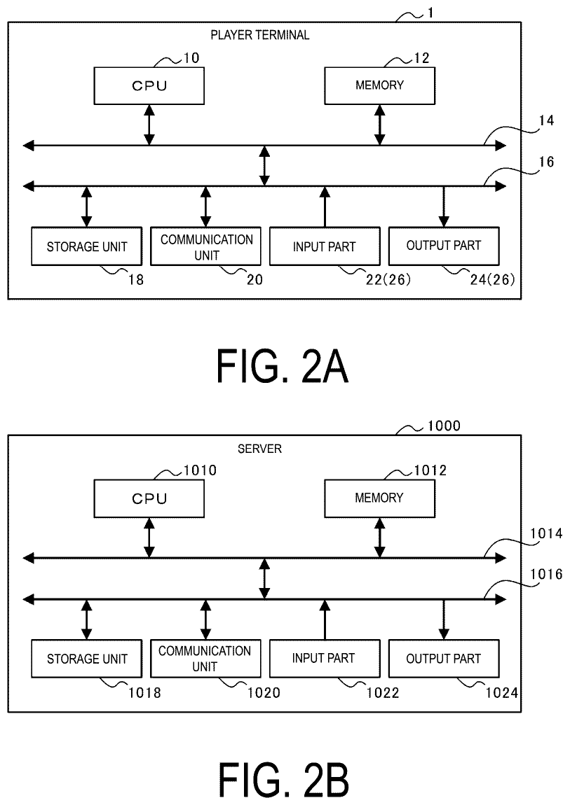

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 1000 includes a CPU 1010, a memory 1012, a bus 1014, an input/output interface 1016, a storage unit 1018, a communication unit 1020, an input part 1022, and an output part 1024.

The configurations and functions of the CPU 1010, the memory 1012, the bus 1014, the input/output interface 1016, the storage unit 1018, the communication unit 1020, the input part 1022, and the output part 1024 of the server 1000 are substantially the same as the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 1000 will be omitted.

The CPU 10 operates a program stored in the memory 12 to control the progress of the game. The memory 12 is constituted by a read-only memory (ROM) or a random-access memory (RAM) and stores programs and various kinds of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is constituted by a semiconductor memory such as a dynamic random access memory (DRAM) and stores various kinds of programs and data. In the player terminal 1, the programs and data stored in the storage unit 18 are loaded into the memory 12 (RAM) by the CPU 10.

The communication unit 20 is wirelessly communicatively connected to the communication base station Na and exchanges information such as various kinds of data and programs with the server 1000 via the communication network N. In the player terminal 1, programs or the like received from the server 1000 are stored in the memory 12 or the storage unit 18.

The input part 22 includes, for example, a touch panel, a button, a keyboard, a mouse, a four-direction key, an analog controller, and the like for inputting player operations (receiving operations). Alternatively, the input part 22 may be a dedicated controller provided in the player terminal 1 or connected (externally attached) to the player terminal 1. Furthermore, the input part 22 may be constituted by an acceleration sensor that detects the inclination or movement of the player terminal 1 or a microphone that detects audio from the player. That is, the input part 22 includes a wide range of apparatuses that allow the player to identifiably input their intention.

The output part 24 includes a display apparatus and a speaker. Note that the output part 24 may be a device connected (externally attached) to the player terminal 1. In the present embodiment, the player terminal 1 includes a touch panel 26 that functions as the input part 22 and the output part 24.

### Details of Game

Next, details of a game provided by the information processing system S (game apparatus G) of the present embodiment will be described using an example. Before starting the game, the player downloads in advance a dedicated application from the server 1000 to the player terminal 1 and registers a player ID in the server 1000. When the application is activated, the player terminal 1 receives various kinds of information stored in the server 1000 and displays a game screen on the touch panel 26.

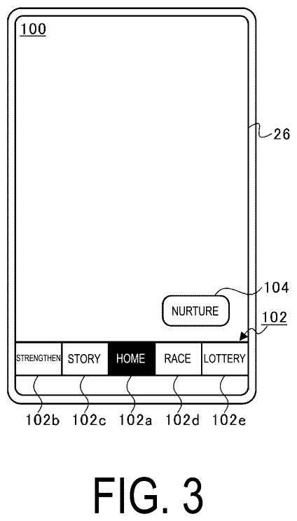

FIG. 3 is a diagram for describing an example of a home screen 100. When the game application is activated on the player terminal 1, the home screen 100 is displayed on the touch panel 26. A menu bar 102 is displayed at a lower portion of the home screen 100. The menu bar 102 is provided with a plurality of operation portions that can be operated (tapped) by the player.

Here, the menu bar 102 is provided with a home screen selection operation portion 102a, a strengthening screen selection operation portion 102b, a story screen selection operation portion 102c, a racing game selection operation portion 102d, and a lottery screen selection operation portion 102e. In the menu bar 102, the operation portion corresponding to the screen being displayed is highlighted so that the screen being displayed on the touch panel 26 can be identified. When the home screen selection operation portion 102a is tapped, the home screen 100 illustrated in FIG. 3 is displayed on the touch panel 26.

When the strengthening screen selection operation portion 102b is tapped, a strengthening screen (not illustrated) is displayed. On the strengthening screen, it is possible to strengthen a nurture game content (lottery object) or support game content possessed by the player. The nurture game content and the support game content are used in the nurture game. In the present embodiment, a plurality of types of nurture game contents and support game contents are provided from the administrator. A player can obtain a nurture game content or support game content via being successful at a lottery called a gacha. In addition, a predetermined nurture game content or support game content may be granted free of charge to the player from the administrator. The player can possess the nurture game content and the support game content obtained via a lottery and the nurture game content and the support game content granted from the administrator.

The player can increase the level set to the nurture game content or the support game content by strengthening the nurture game content or the support game content. Various parameters are set for the nurture game content and the support game content, and the parameters increase as the level increases. By increasing the parameters of the nurture game content and the support game content, the player can nurture a nurture game content having a stronger status in the nurture game.

A nurture game content ID is set for each nurture game content. A support game content ID is set for each support game content. In addition, one game content ID is always associated with a nurture game content or support game content, that is, a nurture game content ID or support game content ID. A game content ID is provided for each game content. Here, the game content is a character, and one character is associated with a game content ID. Thus, one character can be considered to be always associated with a nurture game content or support game content. Hereinafter, the game content may be referred to as a character. In addition, a nurture game content possessed by the player may be referred to as a possessed nurture game content, and a character associated with the possessed nurture game content may be referred to as a possessed character. In addition, a support game content possessed by the player may be referred to as a possessed support game content, and a character associated with the possessed support game content may be referred to as a possessed support character.

When the story screen selection operation portion 102c is tapped, a story screen (not illustrated) is displayed. Here, a story image is provided for each character appearing in the game. The player can select and view a character and a story image on the story screen.

When the racing game selection operation portion 102d is tapped, a racing game selection screen (not illustrated) is displayed. In the present embodiment, various racing games are provided in which a nurtured character nurtured in a nurture game can be entered. On the racing game selection screen, the player can select a racing game in which the nurtured character is entered. An example of a racing game is a team competition game in which a team formed by a plurality of nurtured characters and a team of other players selected by a computer are made to compete with each other. The team competition game has a game property of competing with other players for ranking.

When the lottery screen selection operation portion 102e is tapped, lottery screens 200A and 200B, which will be described in detail later, are displayed. On the lottery screens 200A and 200B, the player can play the lottery by spending in-game currency. A player can obtain a nurture game content and support game content via being successful in the lottery.

In addition, on the home screen 100, a nurture game operation portion 104 is provided above the menu bar 102. When the nurture game operation portion 104 is tapped, a nurture game screen is displayed. In the nurture game, the player can select any one possessed character as the nurture target character by selecting a possessed nurture game content. In the nurture game, by selecting a possessed support game content, the player can select a possessed support character as an assist character that assists in nurturing the nurture target character. Then, in the nurture game, by nurturing the nurture target character while receiving assistance from the assist character, various parameters associated with the nurture target character are updated, and a nurtured character is finally generated. The player can play the above-described racing game or the like using the nurtured character generated in the nurture game.

Note that the details of the game described above is merely an example. The technical matters described below are applicable not only to a nurture game but also to any game genre such as a sports game, an action game, a shooting game, a simulation game, a roll playing game (RPG), and a puzzle game. Regarding the lottery of the game described above, in the present embodiment, a nurture game content and a support game content are described as examples of a game content that can be obtained by lottery. However, no such limitation is intended, and a game content (lottery object) that can be obtained by a lottery only needs to be a lottery target with a lottery animation, and may be, for example, items, equipment, outfits, or the like.

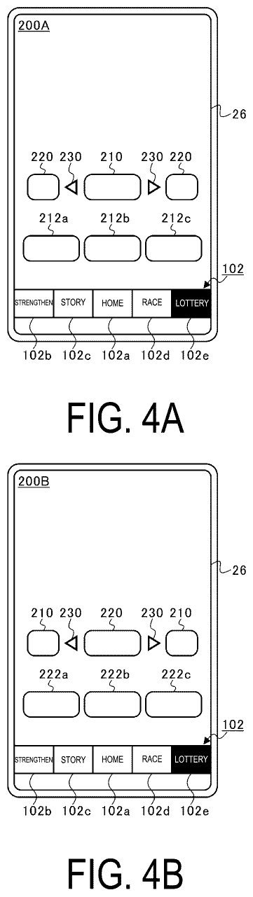

FIG. 4A is a diagram illustrating an example of the lottery screen 200A of the nurture game content. FIG. 4B is a diagram illustrating an example of the lottery screen 200B of the support game content. When the lottery screen selection operation portion 102e is tapped, the lottery screen 200A illustrated in FIG. 4A is displayed. However, when the lottery screen selection operation portion 102e is tapped, the lottery screen 200B illustrated in FIG. 4B may be displayed.

As illustrated in FIG. 4A, the lottery screen 200A is provided with a nurture game content lottery identification portion 210, a support game content lottery identification portion 220, and a switch selection operation portion 230. The nurture game content lottery identification portion 210 allows the player to identify that a nurture game content can be obtained via a lottery. The support game content lottery identification portion 220 allows the player to identify that a support game content can be obtained via a lottery.

The switch selection operation portion 230 is an operation portion for switching between the nurture game content lottery identification portion 210 and the support game content lottery identification portion 220. The player can select either the nurture game content lottery identification portion 210 or the support game content lottery identification portion 220 by tapping the switch selection operation portion 230. When the nurture game content lottery identification portion 210 is selected by the switch selection operation portion 230, the lottery screen 200A illustrated in FIG. 4A can be displayed on the display 26. Further, when the support game content lottery identification portion 220 is selected by the switch selection operation portion 230, the lottery screen 200B illustrated in FIG. 4B can be displayed on the display 26. In this manner, via the switch selection operation portion 230, the lottery screen 200A for performing a nurture game content lottery and the lottery screen 200B for performing a support game content lottery are switched.

As illustrated in FIG. 4A, the lottery screen 200A for performing a nurture game content lottery is provided with a time limit lottery selection operation portion 212a, a variable lottery selection operation portion 212b, and a set lottery selection operation portion 212c.

The player selects and taps either the time limit lottery selection operation portion 212a, the variable lottery selection operation portion 212b, or the set lottery selection operation portion 212c to perform a nurture game content lottery.

The time limit lottery selection operation portion 212a is an operation portion capable of performing a nurture game content lottery (hereinafter referred to as a time limit nurture game content lottery) a predetermined number of times within a limited time period. The period during which the time limit nurture game content lottery can be performed is one day, and the predetermined number of times that the time limit nurture game content lottery can be performed is, for example, one time. By performing the time limit nurture game content lottery one time, the player can obtain one nurture game content via the lottery from among the plurality of nurture game contents provided by the administrator.

For example, by tapping the time limit lottery selection operation portion 212a, the player can perform the time limit nurture game content lottery only once a day. The number of times that the time limit nurture game content lottery can be performed is reset at a predetermined time each day. For example, the number of times that the time limit nurture game content lottery can be performed is reset at 5:00 am. In this case, the player can perform the time limit nurture game content lottery a predetermined number of times (for example, once) from 5:00 am on one day to 4:59 am on the next day, and can perform the time limit nurture game content lottery a predetermined number of times (for example, once) from 5:00 am on the next day to 4:59 am on the next day after.

The time limit nurture game content lottery can be performed by spending in-game currency. The in-game currency includes paid in-game currency and free in-game currency. The paid in-game currency is in-game currency that can be purchased by the player by spending from their own assets. The free in-game currency is in-game currency given by the administrator to the player free of charge. Note that the paid in-game currency and the free in-game currency are the same in-game currency, and it is identified whether the player has obtained the in-game currency via payment or for free.

The time limit nurture game content lottery cannot be performed by spending free in-game currency, and can be performed only by spending paid in-game currency. However, in the time limit nurture game content lottery, since the number of lotteries that can be executed within a predetermined period is less than in the selected number of times nurture game content lottery described later, the amount of paid in-game currency spent is less than in the selected number of times nurture game content lottery. For example, the amount of paid in-game currency spent in the time limit nurture game content lottery is “50”, and the amount of paid in-game currency spent in the selected number of times nurture game content lottery is “150”.

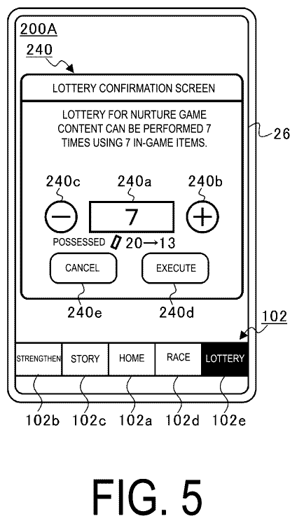

The variable lottery selection operation portion 212b is an operation portion for selecting the number of nurture game content lotteries. The variable lottery selection operation portion 212b is configured to select the number of nurture game content lotteries within a predetermined number range. The player can perform nurture game content lotteries the number of times selected within the predetermined number range (hereinafter also referred to as selected number of times nurture game content lottery). That is, the player can select the number of nurture game content lotteries within a predetermined number range by operating the variable lottery selection operation portion 212b. The predetermined number range is, for example, a range from 1 to 10 times. The player can select the number of nurture game content lotteries in a range from 1 to 10 by operating the variable lottery selection operation portion 212b. The method of selecting the number of lotteries in a range from 1 to 10 will be described later in detail with reference to FIG. 5. However, it is possible to designate one time for the number of lotteries, or designate any number of two or more via an operation of the player.

The selected number of times nurture game content lottery can be performed by spending either paid in-game currency, free in-game currency, or an in-game item. For example, the selected number of times nurture game content lottery can be performed by spending an amount equal to “150” paid in-game currency, an amount equal to “150” free in-game currency, or an amount equal to “1” in-game item. The in-game item is a so-called gacha ticket, and can be given to the player by the administrator free of charge or can be obtained when the player clears a specific mission in the game.

The priority is set for the paid in-game currency, the free in-game currency, and the in-game item. In the present embodiment, the free in-game currency has a higher priority than the paid in-game currency, and the in-game item has a higher priority than the free in-game currency. Thus, in a case where the selected number of times nurture game content lottery can be performed with any of the paid in-game currency, the free in-game currency, and the in-game item, spending of the in-game item is prioritized when the selected number of times nurture game content lottery is performed. Further, in a case where there are not enough in-game items and the selected number of times nurture game content lottery can be performed with either the paid in-game currency or the free in-game currency, spending of the free in-game currency is prioritized when the selected number of times nurture game content lottery is performed.

The selected number of times nurture game content lottery can be executed when the amount of the paid in-game currency, the free in-game currency, or the in-game item possessed by the player is equal to or greater than the amount of the paid in-game currency, the free in-game currency, or the in-game item spend for the number of lotteries designated by the player. When the variable lottery selection operation portion 212b is tapped, a lottery confirmation screen 240 is displayed on the display 26.

FIG. 5 is a diagram illustrating an example of the lottery confirmation screen 240. As illustrated in FIG. 5, the lottery confirmation screen 240 includes a number of lotteries confirmation portion 240a, a plus operation portion 240b, a minus operation portion 240c, an execution operation portion 240d, and a cancel operation portion 240e.

The number of lotteries confirmation portion 240a displays the number of lotteries of the selected number of times nurture game content lottery designated by the player. In the example illustrated in FIG. 5, “7” is displayed in the number of lotteries confirmation portion 240a, and it can be confirmed that the number of lotteries designated by the player is seven times.

The number of in-game items possessed by the player is displayed below the number of lotteries confirmation portion 240a. In the present embodiment, the in-game item is a gacha ticket, and the number of gacha tickets possessed by the player is displayed below the number of lotteries confirmation portion 240a. In the example illustrated in FIG. 5, the number of gacha tickets possessed by the player is “20”.

On the right side of the number of gacha tickets possessed by the player, the remaining number of gacha tickets when the lottery is executed is displayed. One gacha ticket is spent for each lottery. Thus, when the number of lotteries designated by the player is seven, seven gacha tickets are spent. Thus, in the example illustrated in FIG. 5, “13” which is the remaining number of the gacha tickets after the lottery execution, is displayed on the right side of the number of the gacha tickets possessed by the player.

Every time the plus operation portion 240b is tapped, the number displayed in the number of lotteries confirmation portion 240a is increased by one, and the number of lotteries can be increased by one. However, an upper limit number is set for the number of lotteries, and in the present embodiment, the upper limit number is “10” times. Thus, the operation of the plus operation portion 240b is enabled until the number displayed in the number of lotteries confirmation portion 240a reaches “10”, and the operation is disabled at the stage when the number reaches “10”.

In a case where a number of lotteries equal to or greater than the number of gacha tickets possessed by the player is selected, the number of lotteries can be increased assuming that the free in-game currency or the paid in-game currency possessed by the player is spent. In this case, the value of the free in-game currency and the paid in-game currency possessed by the player may be displayed below the number of lotteries confirmation portion 240a. In addition, the value of the free in-game currency and the paid in-game currency remaining after the number of lotteries is executed may be displayed below the number of lotteries confirmation portion 240a.

When the number of lotteries selected by the player is the number of lotteries that cannot be performed even when all of the gacha tickets, the free in-game currency, and the paid in-game currency possessed by the player are spent, that number of lotteries cannot be performed. Thus, when the number of lotteries selected by the player is the number of lotteries that cannot be performed even when all of the gacha tickets, the free in-game currency, and the paid in-game currency possessed by the player are spent, the operation of the plus operation portion 240b is disabled. The operation of the plus operation portion 240b may be disabled when the number of lotteries equal to or greater than the number of gacha tickets possessed by the player is selected by the player.

Every time the minus operation portion 240c is tapped, the number displayed in the number of lotteries confirmation portion 240a is decreased by one, and the number of lotteries can be decreased by one. However, a lower limit number is set for the number of lotteries, and in the present embodiment, the lower limit number is “1” time. Thus, the operation of the minus operation portion 240c is enabled until the number displayed in the number of lotteries confirmation portion 240a reaches “1”, and the operation is disabled at the stage when the number reaches “1”. When the number of lotteries is changed by the plus operation portion 240b and the minus operation portion 240c, the value of the spend amount of the in-game item and the value of the number of executions displayed on the lottery confirmation screen 240 illustrated in FIG. 5 are also changed according to the changed number of lotteries.

When the execution operation portion 240d is tapped, the number displayed on the number of lotteries confirmation portion 240a is determined as the number of lotteries for the selected number of times nurture game content lottery designated by the player. Information relating to the determined number of lotteries is transmitted to the server 1000, and lottery processing of the selected number of times nurture game content lottery is executed for determined number of lotteries on the server 1000 side.

When the cancel operation portion 240e is tapped, the selected number of times nurture game content lottery is canceled and the lottery confirmation screen 240 is closed. In this case, the lottery screen 200A is displayed on the display 26.

Returning to FIG. 4A, the set lottery selection operation portion 212c is an operation portion for performing a lottery for nurture game content with a predetermined number of lotteries as one set (hereinafter, referred to as a set nurture game content lottery). In the set nurture game content lottery, for example, the lottery of the nurture game content is performed with ten number of lotteries as one set. In the set nurture game content lottery, the player cannot select the number of lotteries other than 10 times which is one set.

The set nurture game content lottery can be performed by spending either paid in-game currency or free in-game currency. For example, the set nurture game content lottery can be performed by spending an amount equal to “1500” paid in-game currency or an amount equal to “1500” free in-game currency.

The set nurture game content lottery may be executed when the amount of the paid in-game currency or the free in-game currency possessed by the player is equal to or greater than the spend amount of the paid in-game currency or the free in-game currency.

As illustrated in FIG. 4B, the lottery screen 200B for a support game content is provided with a time limit lottery selection operation portion 222a, a variable lottery selection operation portion 222b, and a set lottery selection operation portion 222c.

Since the configurations of the time limit lottery selection operation portion 222a, the variable lottery selection operation portion 222b, and the set lottery selection operation portion 222c are the same as those of the time limit lottery selection operation portion 212a, the variable lottery selection operation portion 212b, and the set lottery selection operation portion 212c, detailed description thereof will be omitted.

The player terminal 1 transmits information related to the lottery selected by the player to the server 1000. The information related to the lottery includes information related to the lottery type. The information related to the lottery type includes, as the lottery type, information indicating the lottery of the nurture game content and information indicating the lottery of the support game content. In addition, the information related to the lottery type includes information indicating the time limit nurture game content lottery, information indicating the selected number of times nurture game content lottery, and information indicating the set nurture game content lottery.

The information related to the lottery includes information related to the number of lotteries. The information related to the number of lotteries is, for example, “1” time in the case of the time limit nurture game content lottery, “10” times in the case of the set nurture game content lottery, and the number of lotteries designated by the player in the case of the selected number of times nurture game content lottery.

Upon receiving the information related to the lottery from the player terminal 1, the server 1000 executes the lottery processing based on the received information related to the lottery, and stores the information related to the lottery processing result. Information related to the lottery processing result is stored in the server 1000 so as to be receivable by the player terminal 1.

Upon receiving the lottery processing result, the player terminal 1 causes the display 26 to display an animation screen where a lottery animation is performed based on the received lottery processing result. Hereinafter, the lottery animation of the nurture game content will be described, and then the lottery animation of the support game content will be described.

The lottery animation of the nurture game content includes animations of a plurality of phases. For example, the lottery animation includes animations of a first phase, a second phase, a third phase, a fourth phase, and a fifth phase. A lottery animation is executed in the order of the first phase, the second phase, the third phase, the fourth phase, and the fifth phase.

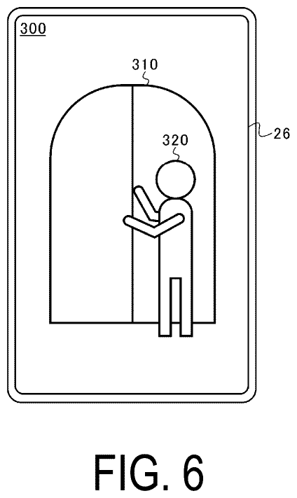

FIG. 6 is a diagram illustrating an example of an animation screen 300 of the first phase of the lottery animation. The animation screen 300 illustrated in FIG. 6 is a screen which is displayed at the start of the lottery animation and is displayed in the first phase of the lottery animation. On the animation screen 300, for example, a three dimensional computer graphic image (hereinafter referred to as a 3DCG image) is displayed. Hereinafter, an animation in which a 3DCG image is displayed is also referred to as a 3DCG animation.

In the example illustrated in FIG. 6, a door 310 and a guide character 320 represented by three dimensional computer graphics (hereinafter referred to as 3DCG) are displayed on the animation screen 300. At the start of the lottery animation, the door 310 is closed, and the guide character 320 is waiting in front of the door 310. Thereafter, the guide character 320 performs an action of opening the door 310, and an animation of inviting the player to a lottery result prepared behind the door 310 is performed. Such a 3DCG image is generated by arranging a 3D model and a virtual camera in a virtual space and virtually capturing an image of the 3D model by the virtual camera.

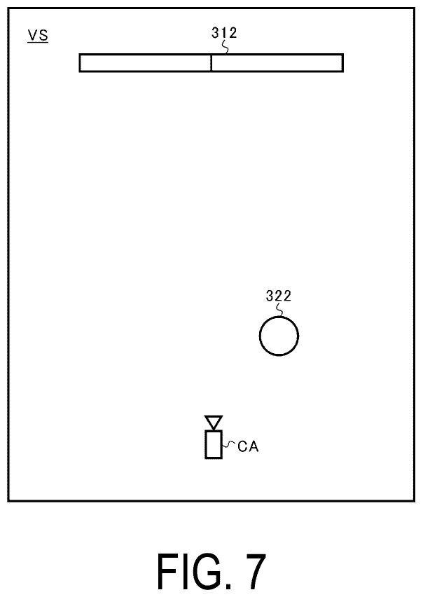

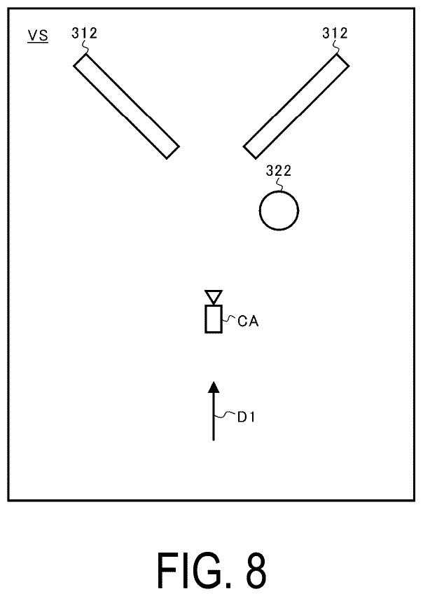

FIG. 7 is a first diagram illustrating a state in which a 3DCG image is generated in the first phase of the lottery animation. FIG. 8 is a second diagram illustrating a state in which a 3DCG image is generated in the first phase of the lottery animation.

As illustrated in FIG. 7, in a virtual space VS, a door model 312 which is a 3D model simulating the door 310, a guide character model 322 which is a 3D model simulating the guide character 320, and a virtual camera CA are arranged. An image virtually captured by the virtual camera CA is a 3DCG image.

The door model 312 and the guide character model 322 are set so as to perform an animation action, and the door model 312 is set to perform an animation action for opening and closing the door 310. In the guide character model 322, an animation action of moving the arms and legs of the guide character 320 is set.

The positions of the door model 312, the guide character model 322, and the virtual camera CA arranged in the virtual space VS are configured to be movable. As illustrated in FIG. 8, in the virtual space VS, the guide character model 322 and the virtual camera CA are moved in an arrow D1 direction toward the door model 312.

Upon reaching the door model 312, the guide character model 322 performs an animation action of moving the arms and legs of the guide character 320 to pull and open the door 310. The door model 312 performs an animation action of opening the door 310 in conjunction with the operation of the guide character model 322. Accordingly, a 3DCG image is generated of an animation of the door 310 being opened by the guide character 320 to invite the player toward the lottery result prepared behind the door 310.

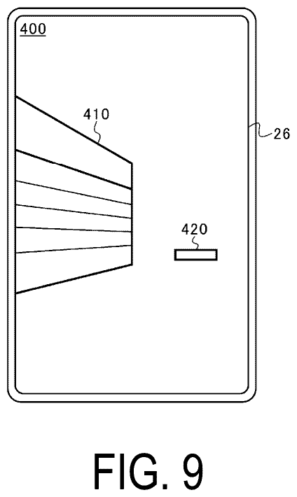

FIG. 9 is a diagram illustrating an example of an animation screen 400 of the second phase of the lottery animation. The animation screen 400 illustrated in FIG. 9 is a screen which is displayed after the first phase and is displayed in the second phase of the lottery animation. In the example illustrated in FIG. 9, a 3DCG image showing a spectator seating 410 and a gate 420 represented by 3DCG is displayed on the animation screen 400.

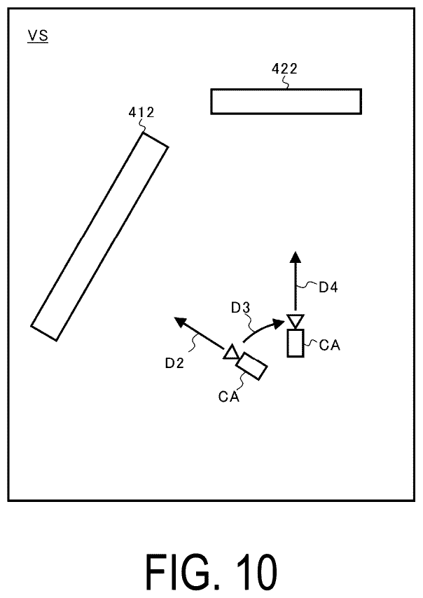

FIG. 10 is a diagram illustrating a state in which a 3DCG image is generated in the second phase of the lottery animation. As illustrated in FIG. 10, in the virtual space VS, a spectator seating model 412 which is a 3D model simulating the spectator seating 410, a gate model (virtual arrangement frame) 422 which is a 3D model simulating the gate 420, and the virtual camera CA are arranged.

In the present embodiment, the virtual camera CA is pointed in an arrow D2 direction toward the spectator seating model 412, and a 3DCG image in which the spectator seat 410 is zoomed in is generated. Thereafter, the viewpoint of the virtual camera CA is moved in an arrow D3 direction to generate a 3DCG image in which an animation performance of moving the viewpoint from the spectator seating 410 toward the gate 420 is performed. Thereafter, the virtual camera CA is pointed in an arrow D4 direction toward the gate 420, and a 3DCG image is generated.

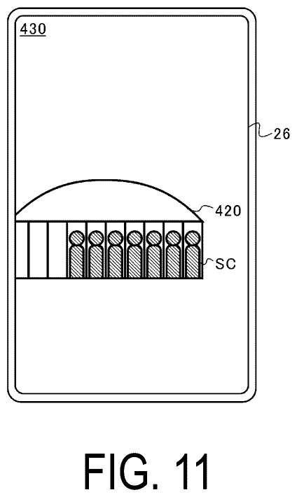

FIG. 11 is a diagram illustrating an example of an animation screen 430 of the third phase of the lottery animation. The animation screen 430 illustrated in FIG. 11 is a screen which is displayed after the second phase and is displayed in the third phase of the lottery animation. In the example illustrated in FIG. 11, a 3DCG image showing the gate 420 and a silhouette of a character (hereinafter referred to as a silhouette character) SC represented by 3DCG is generated on the animation screen 430. On the animation screen 430 of the third phase, an enlarged animation is executed to display the gate 420 and the silhouette character SC in a zoomed-in manner.

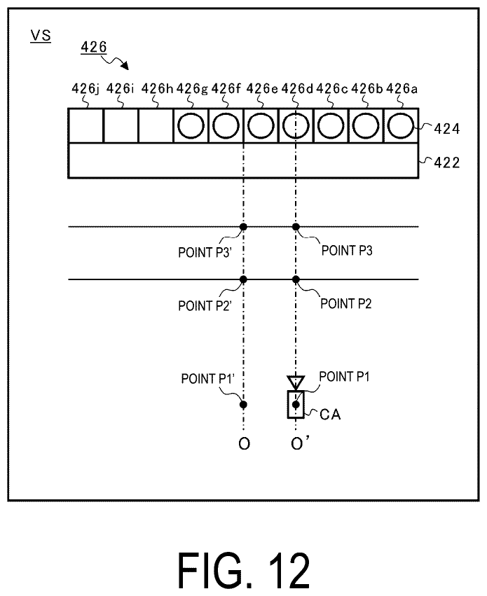

FIG. 12 is a diagram illustrating a state in which a 3DCG image is generated in the third phase of the lottery animation according to the present embodiment. As illustrated in FIG. 12, a gate model 422, a silhouette character model (common object) 424 simulating a silhouette character, and the virtual camera CA are arranged in the virtual space VS.

The silhouette character model 424 is, for example, a 3D model simulating a human figure. However, the present invention is not limited thereto, and the silhouette character model 424 may be a 3D model simulating an organism or animals other than a human or may be a 3D model simulating a specific nurture game content. In addition, the silhouette character model 424 may be a character of a game content painted in black or may be an exclusive model used only in a lottery animation. The silhouette character model 424 may be, for example, a model of a cylindrical three-dimensional object instead of a living object. The silhouette character model 424 is set to, for example, black or gray so that the entire silhouette cannot be seen.

A plurality of arrangement spaces (lottery result arrangement positions) 426 in which the silhouette character models 424 can be arranged are provided behind the gate model 422. The arrangement space 426 includes a first arrangement space 426a, a second arrangement space 426b, a third arrangement space 426c, a fourth arrangement space 426d, a fifth arrangement space 426e, a sixth arrangement space 426f, a seventh arrangement space 426g, an eighth arrangement space 426h, a ninth arrangement space 426i, and a tenth arrangement space 426j. Hereinafter, the first arrangement space 426a to the tenth arrangement space 426j are also collectively referred to as the arrangement spaces 426.

The number of arrangement spaces 426 corresponds to the upper limit number of lotteries. In the present embodiment, the upper limit number of lotteries is “10” times. Thus, in the present embodiment, “10” locations of the first arrangement space 426a to the tenth arrangement space 426j are provided.

The number of the silhouette character models 424 provided corresponds to the number of lotteries designated by the player. For example, when the player selects the time limit nurture game content lottery, one silhouette character model 424 is arranged because the number of lotteries is “1”. Further, when the player selects the set nurture game content lottery, ten silhouette character models 424 are arranged because the number of lotteries is “10”. When the player selects the selected number of times nurture game content lottery, the number of silhouette character models 424 arranged corresponds to the number of lotteries designated by the player.

In this manner, since the silhouette character models 424 are arranged in accordance with the number of lotteries, the player can visually comprehend that the lottery results corresponding to the number of lotteries are presented, by comprehending the number of silhouette character models 424.

In the example illustrated in FIG. 12, the number of lotteries designated by the player is “7” times, and seven silhouette character models 424 are arranged. The silhouette character models 424 are arranged in order from the first arrangement space 426a to the tenth arrangement space 426j. In the present embodiment, seven silhouette character models 424 are sequentially arranged in the first arrangement space 426a to the seventh arrangement space 426g. In this manner, the silhouette character models 424 are arranged according to a predetermined criterion so as to be aligned in a line in a direction (predetermined direction) from the first arrangement space 426a toward the tenth arrangement space 426j. However, the silhouette character models 424 may be arranged to be aligned in a line in a direction from the tenth arrangement space 426j toward the first arrangement space 426a. In addition, they may be arranged from the center side toward both end sides or may be arranged at random without an order.

A center line O is a line passing through the center position of the gate model 422, that is, between the fifth arrangement space 426e and the sixth arrangement space 426f. A center line O′ is a line that is parallel with the center line O and passes through the center of the fourth arrangement space 426d.

As illustrated in FIG. 12, in the present embodiment, the virtual camera CA is arranged at a point P1 on the center line O′. The position where the virtual camera CA is arranged is determined based on the number of lotteries designated by the player or the position of the silhouette character models 424, that is, the position of the arrangement spaces 426 where the silhouette character models 424 are arranged.

For example, when the number of lotteries is “10” times, that is, the upper limit, the silhouette character models 424 are arranged in all of the first arrangement space 426a to the tenth arrangement space 426j of the arrangement spaces 426. In this case, the virtual camera CA is arranged at a position between the fifth arrangement space 426e and the sixth arrangement space 426f corresponding to the center of the first arrangement space 426a to the tenth arrangement space 426j, that is, at a point P1′ on the center line O aligned at the center position of the gate model 422.

In the example illustrated in FIG. 12, since the number of lotteries is “7” times, that is, less than the upper limit, the virtual camera CA is arranged on the center line O′ aligned at the center position of the fourth arrangement space 426d corresponding to the center of the first arrangement space 426a to the seventh arrangement space 426g in which the silhouette character models 424 are arranged. That is, the virtual camera CA is arranged on the center line of the arrangement spaces 426 in which the silhouette character models 424 are arranged.

In this manner, in the present embodiment, the point P1 which is the arrangement position of the virtual camera CA is changed based on the number of lotteries designated by the player or the positions of the arrangement spaces 426 where the silhouette character models 424 are arranged. The offset amount between the center line O which is the center position of the gate model 422 and the center line O′ is changed in accordance with the number of lotteries designated by the player. Since the arrangement of the virtual camera CA is controlled to be changed according to the number of lotteries selected by the player, the lottery animation displayed on the display 26 is also changed. Thus, by the player selecting the number of lotteries, the player can obtain a feeling as if they are selecting the lottery animation, and the lottery in the game can be enjoyed.

As described above, according to the present embodiment, since the position of the virtual camera CA changes in accordance with the number of lotteries designated by the player, it is possible to change the lottery animation in accordance with the number of lotteries. Since the entire screen of the lottery animation is changed according to the number of lotteries, the lottery animation using 3D models can have a richer expression, and the player's enjoyment can be enhanced. In addition, since a focus is put on the number of silhouette character models 424 being arranged according to the number of lotteries selected by the player themself, the player can comprehend the overall lottery result and the number of lotteries at a glance, and an animation with enhanced visibility can be provided to the player.

In the example illustrated in FIG. 12, the virtual camera CA is arranged at the point P1 on the center line O′ and is then moved to a point P2 and then a point P3 on the center line O′ so as to approach the gate model 422. The point P1 is the initial position of the virtual camera CA and is a position farther away from a position at which the entire gate 420 can be seen, which is the lottery result arrangement position. The point P2 is a point between the point P1 and the point P3 and is located closer to the point P3 than an intermediate point between the point P1 and the point P3 in the present embodiment. Further, the point P2 is a point at which a non-arrangement space (the arrangement space 426h in FIG. 12) where no silhouette character model 424 is arranged, from among the arrangement spaces 426, is located at an end of the field of view of the virtual camera CA and is a position at which the entire silhouette of the silhouette character model 424 becomes vaguely visible. The point P3 is a position at which the entire silhouette of the silhouette character model 424 representing a lottery target can be clearly seen and is a position at which the entire silhouette of the silhouette character model 424 can be seen so as to fill up the angle of view of the virtual camera CA. The point P3 is also the stopping position of the virtual camera CA.

The virtual camera CA is controlled to move from the point P1 to the point P2 at a first speed and is controlled to move from the point P2 to the point P3 at a second speed slower than the first speed. That is, the virtual camera CA moves from the point P1 to the point P2 at a high speed and moves from the point P2 to the point P3 at a low speed. Since the distance from the point P1 to the point P2 is longer than the distance from the point P2 to the point P3, by moving the virtual camera CA from the point P1 to the point P2 at a high speed, it is possible to make an dynamic animation with rapid approach toward the gate model 422 and the silhouette character model 424. Further, by moving the virtual camera CA from the point P2 to the point P3 at a low speed, the gate model 422 and the silhouette character model 424 which are rapidly approaching are slowly enlarged to create an even more dynamic animation. In the present embodiment, the speed and the field of view of the virtual camera CA are changed in two stages but may be changed in one stage or three or more stages.

When the virtual camera CA moves from the point P1 to the point P2 then to the point P3, the gate model 422 and the silhouette character model 424 are zoomed in and enlarged (zoomed) (hereinafter also referred to as an enlarged animation). However, an enlarged animation of the gate model 422 and the silhouette character model 424 using the zoom function of the virtual camera CA may be performed without moving the virtual camera CA. Further, the movement of the virtual camera CA and the zoom function of the virtual camera CA may be used together. For example, the enlarged animation may be performed by moving the virtual camera CA from the point P1 to the point P2 and zooming in with the virtual camera CA from the point P2 to the point P3. In addition, the virtual camera CA may be zoomed in from the point P1 to the point P2 and moved from the point P2 to the point P3 to perform the enlarged animation.

When the number of lotteries is “10” times, that is, the upper limit, the virtual camera CA moves along the center line O from the point P1′ to a point P2′ to a point P3′. The point P1′, the point P2′, and the point P3′ on the center line O are positions corresponding to the point P1, the point P2, and the point P3 on the center line O′. The points P1 and P1′, the points P2 and P2′, and the points P3 and P3′ are the same distance from the gate model 422.

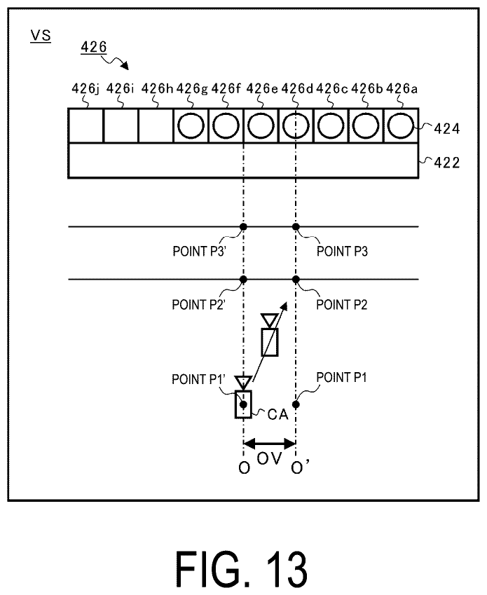

FIG. 13 is a diagram illustrating a state in which a 3DCG image is generated in the third phase of the lottery animation according to a first modified example. Here, portions different from the above-described embodiment will be described in detail, and portions that are the same as in the above-described embodiment will not be described.

In the third phase of the lottery animation according to the first modified example, the initial position of the virtual camera CA is different from that in the above-described embodiment. As illustrated in FIG. 13, the point P1′ which is the initial position of the virtual camera CA is arranged on the center line O. The point P1 in the above-described embodiment and the point P1′ in the first modified example are the same distance from the gate model 422. The point P1 and the point P1′ are separated from each other by an offset amount OV in the left-and-right direction in FIG. 13.

In the first modified example, the virtual camera CA is moved from the point P1′ on the center line O to the point P2 on the center line O′ to the point P3 on the center line O′. That is, in the first modified example, after the virtual camera CA is arranged to be aligned at the center position of the gate model 422, control is performed so that the virtual camera CA is moved from the center position of the gate model 422 to the center position of the arrangement spaces 426 where the silhouette character models 424 are arranged.

The virtual camera CA moves by the offset amount OV in the left-and-right direction in FIG. 13 from the point P1′ to the point P2. From the point P1′ to the point P2, the offset amount of the virtual camera CA is offset-controlled by the formula OV×((Tc−Ts)/(T1−Ts)). Here, Ts is a movement start time of the virtual camera CA from the point P1′. Tc is the current time. T1 is the arrival target time of the virtual camera CA at the point P2 and is the offset end time.

Thus, even when the moving distance of the virtual camera CA is changed according to the number of lotteries designated by the player, the enlarged animation can be performed by moving from the point P1′ to the point P2 while smoothly offsetting the virtual camera CA, and the lottery animation can be changed according to the number of lotteries. In addition, since the offset amount OV changes according to the number of lotteries, it is possible to increase the amount of change in the movement of the virtual camera CA as compared with the above-described embodiment, and it is possible to make the animation more dynamic. As a result, the player's enjoyment can be enhanced.

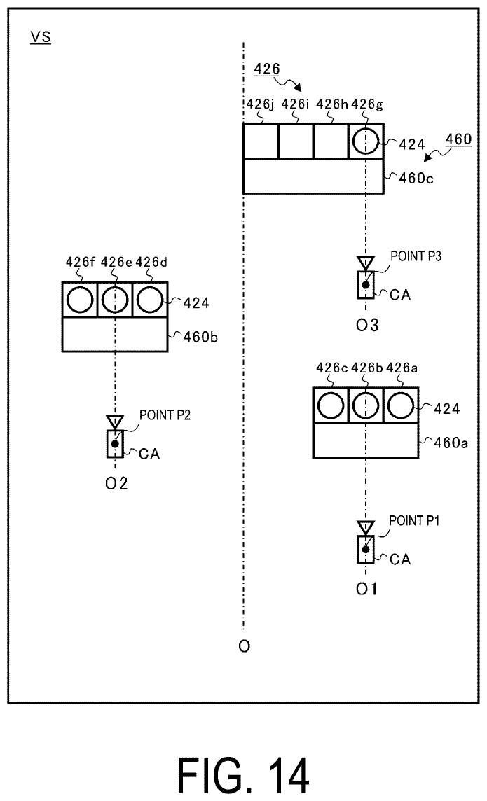

FIG. 14 is a diagram illustrating a state in which a 3DCG image is generated in the third phase of the lottery animation according to a second modified example. Here, portions different from the above-described embodiment will be described in detail, and portions that are the same as in the above-described embodiment will not be described.

In the third phase of the lottery animation according to the second modified example, the position and the shape of the gate model 422 are different from those in the above-described embodiment. As illustrated in FIG. 14, a gate model 460 of the second modified example includes a first gate model 460a, a second gate model 460b, and a third gate model 460c.

The first gate model 460a is provided apart from the second gate model 460b in the left-and-right direction in FIG. 14. The second gate model 460b is provided apart from the third gate model 460c in the left-and-right direction in FIG. 14. The first gate model 460a is provided offset from the third gate model 460c in the left-and-right direction in FIG. 14.

The first gate model 460a, the second gate model 460b, and the third gate model 460c are provided apart from each other in the up-and-down direction (depth direction) in FIG. 14. The first arrangement space 426a, the second arrangement space 426b, and the third arrangement space 426c are provided behind the first gate model 460a.

The fourth arrangement space 426d, the fifth arrangement space 426e, and the sixth arrangement space 426f are provided behind the second gate model 460b. The seventh arrangement space 426g, the eighth arrangement space 426h, the ninth arrangement space 426i, and the tenth arrangement space 426j are provided behind the third gate model 460c.

In the example illustrated in FIG. 14, the number of lotteries designated by the player is “7” times, and seven silhouette character models 424 are arranged. The silhouette character models 424 are arranged in order from the first arrangement space 426a to the tenth arrangement space 426j. In the second modified example, seven silhouette character models 424 are sequentially arranged in the first arrangement space 426a to the seventh arrangement space 426g.

In the example illustrated in FIG. 14, the silhouette character models 424 are arranged in the first arrangement space 426a to the third arrangement space 426c provided behind the first gate model 460a. Further, the silhouette character models 424 are arranged in the fourth to sixth arrangement spaces 426d to 426f provided behind the second gate model 460b. Further, the silhouette character model 424 is arranged in the seventh arrangement space 426g provided behind the third gate model 460c.

In the second modified example, seven silhouette character models 424 are divided into a first group arranged in the first arrangement space 426a to the third arrangement space 426c, a second group arranged in the fourth arrangement space 426d to the sixth arrangement space 426f, and a third group arranged in the seventh arrangement space 426g. However, the present invention is not limited thereto, and it is sufficient that the plurality of silhouette character models 424 are divided into at least the first group and the second group, and the number of divisions may be three or more.

In the example illustrated in FIG. 14, the three silhouette character models 424 of the first group are sequentially arranged in the first arrangement space 426a to the third arrangement space 426c. In this manner, the silhouette character models 424 are arranged according to a predetermined criterion so as to be aligned in a line in a direction (predetermined direction) from the first arrangement space 426a toward the third arrangement space 426c.

Further, the three silhouette character models 424 of the second group are sequentially arranged in the fourth arrangement space 426d to the sixth arrangement space 426f. In this manner, the silhouette character models 424 are arranged according to a predetermined criterion so as to be aligned in a line in a direction (predetermined direction) from the fourth arrangement space 426d toward the sixth arrangement space 426f.

One silhouette character model 424 of the third group is arranged in the seventh arrangement space 426g. In this manner, the silhouette character models 424 are arranged according to a predetermined criterion so as to be aligned in a line in a direction (predetermined direction) from the seventh arrangement space 426g toward the tenth arrangement space 426j.

The center line O is a line passing through a center position of all the gate models 460 including the first gate model 460a, the second gate model 460b, and the third gate model 460c in the left-and-right direction in FIG. 14. That is, the center line O is a line passing through an intermediate position between the rightmost end and the leftmost end of the first gate model 460a, the second gate model 460b, and the third gate model 460c.

A center line O1 is a line that is parallel with the center line O and passes through the center position of the first gate model 460a and the center position of the second arrangement space 426b. The center line O2 is a line that is parallel with the center line O and passes through the center position of the second gate model 460b and the center position of the fifth arrangement space 426e. The center line O3 is a line that is parallel with the center line O and passes through the center position of the seventh arrangement space 426g.

In the example illustrated in FIG. 14, the virtual camera CA is arranged at the point P1 on the center line O1 and then moved to the point P2 on the center line O2 and then the point P3 on the center line O3. The silhouette character models 424 are arranged in the first arrangement space 426a to the third arrangement space 426c provided behind the first gate model 460a. Thus, in the second modified example, the virtual camera CA is arranged on the center line O1 aligned at the center of the first arrangement space 426a to the third arrangement space 426c, that is, the center position of the second arrangement space 426b which is the center of the first group.

The silhouette character models 424 are arranged in the fourth arrangement space 426d to the sixth arrangement space 426f provided behind the second gate model 460b. Thus, in the second modified example, the virtual camera CA is arranged on the center line O2 aligned at the center of the fourth arrangement space 426d to the sixth arrangement space 426f, that is, the center position of the fifth arrangement space 426e which is the center of the second group.

The silhouette character model 424 is arranged in the seventh arrangement space 426g provided behind the third gate model 460c. Thus, in the second modified example, the virtual camera CA is arranged on the center line O3 aligned at the center of the seventh arrangement space 426g, that is, the center position of the seventh arrangement space 426g which is the center of the third group.

Thus, the enlarged animation can be performed while moving the virtual camera CA so that the viewpoint is switched from the point P1 to the point P2 to the point P3 according to the number of lotteries designated by the player, and the lottery animation can be changed according to the number of lotteries. In addition, since the virtual camera CA moves so as to switch to being aligned at the center of each group, it is possible to more dynamically move the virtual camera CA compared to the above-described embodiment and the first modified example and to make the animation more dynamic. As a result, the player's enjoyment can be enhanced.

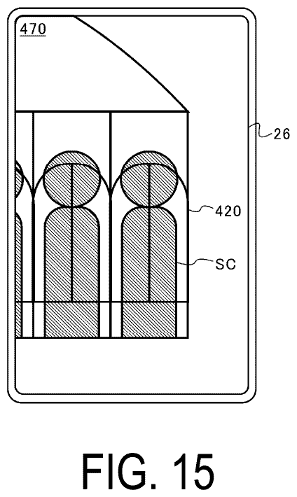

FIG. 15 is a diagram illustrating an example of an animation screen 470 of the fourth phase of the lottery animation. The animation screen 470 illustrated in FIG. 15 is a screen which is displayed after the third phase and is displayed in the fourth phase of the lottery animation. In the example illustrated in FIG. 15, a 3DCG image showing the zoomed-in silhouette character SC and a part of the gate 420 is generated on the animation screen 470.

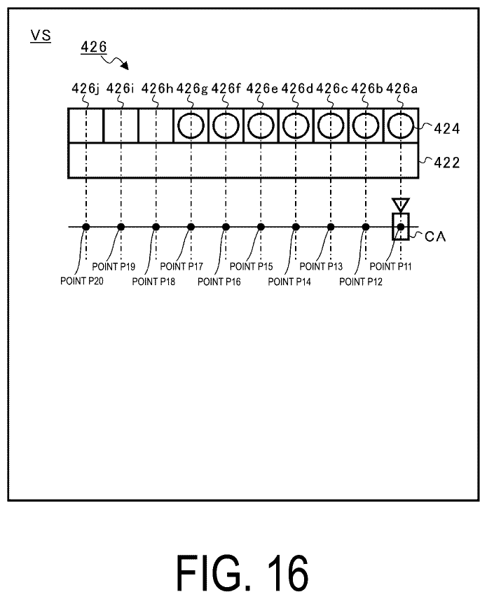

FIG. 16 is a diagram illustrating a state in which a 3DCG image is generated in the fourth phase of the lottery animation. As illustrated in FIG. 16, the gate model 422, the silhouette character models 424, and the virtual camera CA are arranged in the virtual space VS. The silhouette character models 424 arranged in the virtual space VS in the animation of the fourth phase may be the same as or different from the silhouette character models 424 arranged in the virtual space VS in the animation of the third phase. For example, the color of the silhouette character models 424 may be changed between the third phase and the fourth phase. Further, the color may be changed for each silhouette character model 424. The silhouette character models 424 may be based on a single model or a plurality of types of models. When there is one model serving as a base, a color or an effect may be changed for each model. Further, in the fourth phase, the model may be replaced with the model of the game content actually determined by the lottery or the model may be colored or provided with an effect.

The first arrangement space 426a to the tenth arrangement space 426j are arranged behind the gate model 422, and a point P11 to a point P20 provided corresponding to the first arrangement space 426a to the tenth arrangement space 426j are provided in front of the gate model 422.

Specifically, the point P11 corresponds to the first arrangement space 426a, the point P12 corresponds to the second arrangement space 426b, the point P13 corresponds to the third arrangement space 426c, the point P14 corresponds to the fourth arrangement space 426d, the point P15 corresponds to the fifth arrangement space 426e, the point P16 corresponds to the sixth arrangement space 426f, the point P17 corresponds to the seventh arrangement space 426g, the point P18 corresponds to the eighth arrangement space 426h, the point P19 corresponds to the ninth arrangement space 426i, and the point P20 corresponds to the tenth arrangement space 426j.

The point P11 to the point P20 are aligned in a predetermined direction. The direction in which the point P11 to the point P20 are aligned is the same as the long side direction of the gate model 422 and the direction in which the first arrangement space 426a to the tenth arrangement space 426j are aligned. That is, the point P11 to the point P20 are arranged along the long side direction of the gate model 422 and the direction in which the first arrangement space 426a to the tenth arrangement space 426j are aligned.

The virtual camera CA is moved in the order of the point P11→the point P12→the point P13→the point P14→the point P15→the point P16→the point P17→the point P18→the point P19→the point P20. The distances between the points from the point P11 to the point P20 are equal to each other, and the speed at which the virtual camera CA moves is also constant. However, the present invention is not limited thereto, and the distances between the points from the point P11 to the point P20 may be different from each other, and the moving speed of the virtual camera CA may also be variable.

Specifically, in the fourth phase, after the enlarged animation entirely on the gate 420 is completed in the lottery animation of the third phase, control processing is executed to horizontally pan the virtual camera CA from the right end (point P11) to the left end (point P20) of the gate 420. At this time, the configuration allows an animation curve to be set for the amount of movement of the virtual camera CA. By setting the animation curve, the administrator can set the virtual camera CA to be movable in the horizontal direction at any adjustable speed. In the present embodiment, the animation curve is set differently between a case where the number of lotteries is less than a predetermined number of times (for example, five times) and a case where the number of lotteries is equal to or greater than a predetermined number of times (for example, five times).

More specifically, the animation curve of the movement amount of the virtual camera CA in a case where the number of lotteries is from one to four (that is, less than five) is different from the animation curve of the movement amount of the virtual camera CA in a case where the number of lotteries is from five to ten (five or greater). For example, when the number of lotteries is four, the virtual camera CA moves from the point P11 toward the point P14. At this time, in the animation curve, the movement amount (or speed) of the virtual camera CA gradually decreases (slows down) from the point P11 toward the point P14. On the other hand, when the number of lotteries is ten, the virtual camera CA moves from the point P11 toward the point P20. At this time, in the animation curve, the movement amount (or speed) of the virtual camera CA is constant from the point P11 to the point P20.

This is because, since the moving distance of the virtual camera CA from the point P11 to the point P14 is short, it is difficult for the player to recognize the gate 420 when the speed of the virtual camera CA is constant. In a case where the moving distance of the virtual camera CA is short, by reducing the speed as the virtual camera CA approaches the stopping position, the player can easily recognize the gate 420 and can further enjoy the lottery animation. In this manner, by adjusting the animation curve so as to adjust the stop operation of the virtual camera CA or to increase or decrease the speed of the operation, the appearance of the lottery animation can be enhanced, and the player can enjoy the lottery animation more.

The virtual camera CA moves so as to sequentially capture the silhouette character models 424 arranged in the first arrangement space 426a to the tenth arrangement space 426j through the gate. In the example illustrated in FIG. 16, seven silhouette character models 424 are arranged in the first arrangement space 426a to the seventh arrangement space 426g. Thus, the virtual camera CA moves so as to capture the silhouette character models 424 in order from the point P11 to the point P17 corresponding to the first arrangement space 426a to the seventh arrangement space 426g. Accordingly, an animation performance is performed in which the viewpoint is moved so that the silhouette characters SC arranged in the gate 420 are shown one by one in the horizontal direction through the gate 420.

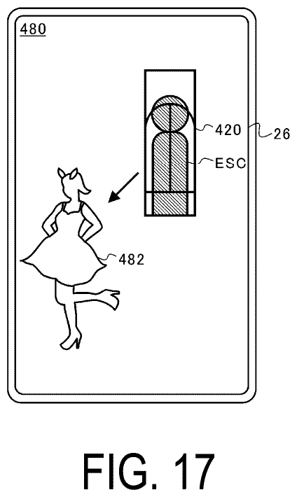

FIG. 17 is a diagram illustrating an example of an animation screen 480 of the fifth phase of the lottery animation. The animation screen 480 illustrated in FIG. 17 is a screen which is displayed after the fourth phase and is displayed in the fifth phase of the lottery animation.

In the example illustrated in FIG. 17, a 3DCG image showing a lottery result character 482 represented as a 3DCG and a part of the gate 420 is generated on the animation screen 480. The lottery result character 482 is arranged in a silhouette state as an exclusive silhouette character ESC in the gate 420 at the beginning of the fifth phase, and when it is released from the gate 420 as time elapses, the silhouette state is removed, and a result animation in which the lottery result character 482 is identified as the lottery result is performed. The result animation is performed the number of times corresponding to the number of lotteries designated by the player. The result animation is performed using an animation performance in which the lottery result character 482 moves in a predetermined pattern. This animation performance is prepared in advance for each lottery result character 482. However, the present invention is not limited thereto, and a result animation may be generated by arranging an exclusive model of the lottery result character 482 in the virtual space VS and virtually capturing the exclusive model with the virtual camera CA as in the animations of the other phases. In this case, at the stage where the exclusive silhouette character ESC is arranged in the gate 420, the exclusive silhouette character model of the lottery result character 482 is arranged in the arrangement space 426 behind the gate model 422.

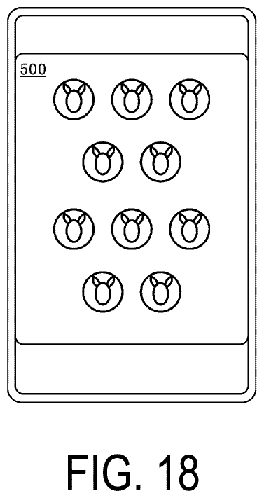

FIG. 18 is a diagram illustrating an example of a lottery result screen 500 of the lottery. As illustrated in FIG. 18, a 2D image of the lottery result character 482 is displayed on the lottery result screen 500. Since there are as many lottery result characters 482 as the number of lotteries designated by the player, the number of 2D images of the lottery result characters 482 displayed on the lottery result screen 500 changes according to the number of lotteries.

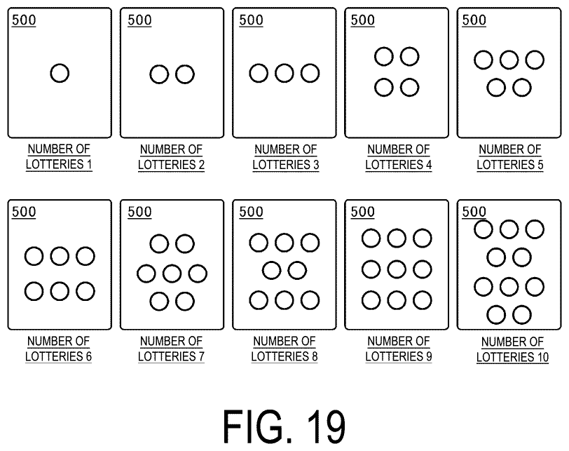

FIG. 19 is a diagram illustrating an example of the lottery result screen 500 that changes according to the number of lotteries. As illustrated in FIG. 19, when the number of lotteries changes between 1 and 10, the number and arrangement of the 2D images of the lottery result characters 482 change.

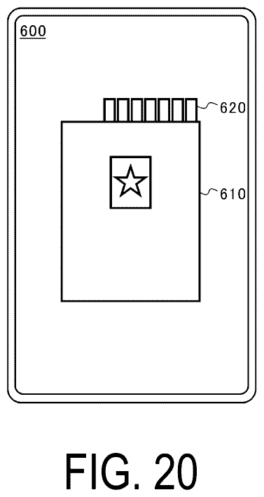

FIG. 20 is a diagram illustrating an example of an animation screen 600 of a lottery animation for a support game content. As illustrated in FIG. 20, a book 610 and a bookmark 620 represented by 3DCG are displayed on the animation screen 600.

The maximum number of bookmarks 620 is set in accordance with the upper limit number of lotteries. In the present embodiment, the upper limit number of lotteries is “10” times. Thus, in the present embodiment, a maximum of “10” bookmarks 620 can be provided.

The number of the bookmarks 620 provided corresponds to the number of lotteries designated by the player. In the example illustrated in FIG. 20, the number of lotteries designated by the player is “7” times. Thus, the number of the bookmarks 620 is “7”.

In this manner, since the number of the bookmarks 620 is provided in accordance with the number of lotteries, the player can visually comprehend the number of lottery results by comprehending the number of the bookmarks 620. In the lottery animation of the support game content, the pages of the book 610 are turned so that the support game content is displayed on the page where each bookmark 620 is inserted. In the lottery animation of the support game content, the model of the book 610 is arranged in the virtual space VS, and the models of the bookmarks 620 are arranged in order from the right side so as to be inserted into the book 610, similarly to the lottery animation of the nurture game content. Then, the virtual camera CA may be arranged at a position corresponding to the center of all the bookmarks 620, and an enlarged animation may be performed. In addition, since the lottery result screen of the lottery for the support game content is similar to the lottery result screen 500 (FIG. 19) of the lottery for the nurture game content, a detailed description thereof will be omitted.

### Functional Configuration and Control Processing in Player Terminal 1

Next, the functional configuration and the control processing in the player terminal 1 for executing the above-described game will be described. In the following description, the functional configurations and control processing related to the lottery will be described in detail, and description of the other configurations and control processing will be omitted.

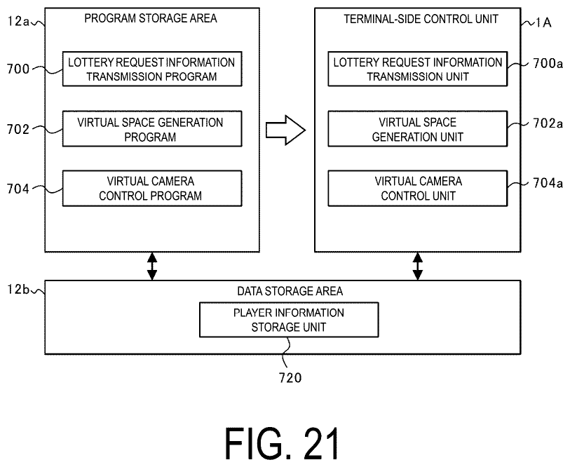

FIG. 21 is a diagram for describing the configuration of the memory 12 in the player terminal 1 and the function as a computer. The memory 12 is provided with a program storage area 12a and a data storage area 12b. When the application is activated, the CPU 10 stores the terminal-side control program (module) in the program storage area 12a.

The terminal-side control program includes a lottery request information transmission program 700, a virtual space generation program 702, and a virtual camera control program 704. The above-described programs are merely examples, and many other programs are also provided in the program storage area 12a.

In the data storage area 12b, a player information storage unit 720 is provided as a storage unit for storing data. The player information storage unit 720 stores possessed nurture game contents and information indicating the possessed characters. The player information storage unit 720 stores information indicating whether nurture game contents and support game contents are possessed or not and information indicating the level of nurture game contents and support game contents. Note that the above-described storage units are merely examples, and many other storage units may be provided in the data storage area 12b. The storage unit is provided with multiple tables.

The CPU 10 operates each program stored in the program storage area 12a and updates the data in each storage unit of the data storage area 12b. Then, the CPU 10 causes the player terminal 1 (computer) to function as a terminal-side control unit 1A by operating each program stored in the program storage area 12a. The terminal-side control unit 1A includes a lottery request information transmission unit 700a, a virtual space generation unit 702a, and a virtual camera control unit 704a.

Specifically, the CPU 10 operates the lottery request information transmission program 700 to cause the computer to function as the lottery request information transmission unit 700a. Similarly, the CPU 10 operates the virtual space generation program 702 and the virtual camera control program 704 to cause the computer to function as the virtual space generation unit 702a and the virtual camera control unit 704a.

When any of the time limit lottery selection operation portions 212a and 222a, the variable lottery selection operation portions 212b (execution operation portion 240d) and 222b, and the set lottery selection operation portions 212c and 222c is tapped on the lottery screen 200A for a nurture game content or the lottery screen 200B for a support game content, the lottery request information transmission unit 700a generates lottery request information, and transmits the generated lottery request information to the server 1000.

The virtual space generation unit 702a generates the virtual space VS and executes processing of arranging a 3D model and a virtual camera in the virtual space VS when executing a lottery animation.

The virtual camera control unit 704a controls the virtual camera arranged in the virtual space VS. Specifically, the virtual camera control unit 704a performs position control, movement control, enlarged animation control, and the like of the virtual camera in the virtual space VS.

### Functional Configuration and Control Processing in Server 1000

Next, the functional configuration and the control processing in the server 1000 for executing the above-described game will be described. In the following description, the functional configurations and control processing related to the lottery will be described in detail, and description of the other configurations and control processing will be omitted.

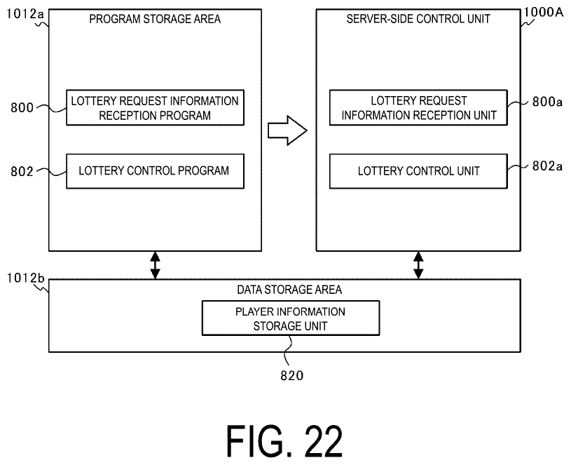

FIG. 22 is a diagram for describing the configuration of the memory 1012 in the server 1000 and the function as a computer. The memory 1012 is provided with a program storage area 1012a and a data storage area 1012b. When the application is activated, the CPU 1010 stores the server-side control program (module) in the program storage area 1012a.

The server-side control program includes a lottery request information reception program 800 and a lottery control program 802. The above-described programs are merely examples, and many other programs are also provided in the program storage area 1012a.

In the data storage area 1012b, a player information storage unit 820 is provided as a storage unit for storing data. The player information storage unit 820 stores information indicating whether nurture game contents and support game contents are possessed or not and information indicating the level of nurture game contents and support game contents. Note that the above-described storage units are merely examples, and many other storage units may be provided in the data storage area 1012b. The storage unit is provided with multiple tables.

The CPU 1010 operates each program stored in the program storage area 1012a and updates the data in each storage unit of the data storage area 1012b. Then, the CPU 1010 causes the server 1000 (computer) to function as a server-side control unit 1000A by operating each program stored in the program storage area 1012a. The server-side control unit 1000A includes a lottery request information reception unit 800a and a lottery control unit 802a.

Specifically, the CPU 1010 operates the lottery request information reception program 800 to cause the computer to function as the lottery request information reception unit 800a. Similarly, the CPU 1010 operates the lottery control program 802 to cause the computer to function as the lottery control unit 802a.

The lottery request information reception unit 800a receives lottery request information transmitted from the player terminal 1.

The lottery control unit 802a determines the lottery type and the number of lotteries based on the lottery request information transmitted from the player terminal 1 and executes lottery processing based on the determined lottery type and the number of lotteries. Next, communication processing between the player terminal 1 and the server 1000 will be described. Here, an example of basic communication processing of progressing the game and main communication processing related to the lottery will be described, and description of other processing will be omitted.

Communication Processing between Player Terminal 1 and Server 1000

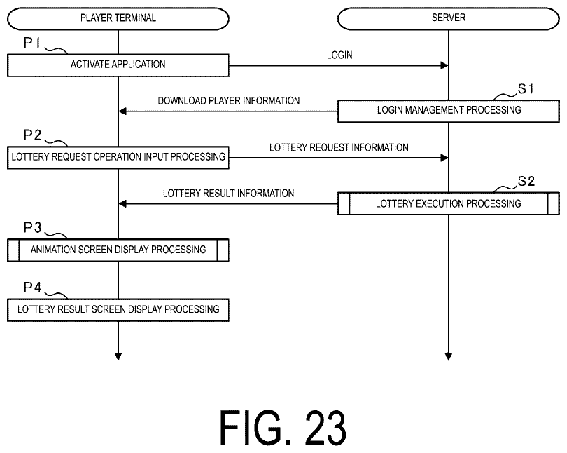

FIG. 23 is a sequence diagram for describing basic processing of the player terminal 1 and the server 1000. In the following description, the processing executed by the player terminal 1 is denoted by Pn (n is a discretionary integer). Processing executed by the server 1000 is denoted by Sn (n is a discretionary integer).

When the player starts the game application in the player terminal 1 (P1), the player terminal 1 transmits information indicating a login to the server 1000. Upon receiving the information indicating a login, the server 1000 identifies a player ID associated with the information and performs login management processing (S1). Here, the server 1000 enables the player terminal 1 to download player information corresponding to the identified player ID from the player information storage unit 820. The player information includes information related to a plurality of nurture game content IDs, support game content IDs, in-game currency, in-game items, and the like associated with the player ID.

The lottery request information transmission unit 700a of the player terminal 1 transmits the lottery request information to the server 1000 when any of the time limit lottery selection operation portion 212a, the variable lottery selection operation portion 212b (execution operation portion 240d), and the set lottery selection operation portion 212c is tapped on the lottery screen 200A for a nurture game content (P2).

The lottery request information includes information related to the lottery type of the nurture game content (that is, information relating to any type of the time limit nurture game content lottery, the selected number of times nurture game content lottery, and the set nurture game content lottery). In addition, the lottery request information includes information related to the number of lotteries (for example, the number of lotteries designated by the player in the case of the selected number of times nurture game content lottery).

Similarly, the lottery request information transmission unit 700a of the player terminal 1 transmits the lottery request information to the server 1000 when any of the time limit lottery selection operation portion 222a, the variable lottery selection operation portion 222b (execution operation portion 240d), and the set lottery selection operation portion 222c is tapped on the lottery screen 200B for a support game content (P2). The lottery request information of the lottery for a support game content includes information relating to the lottery type for the support game content and information relating to the number of lotteries, similarly to the lottery request information of the lottery for a nurture game content.

Upon receiving the lottery request information from the player terminal 1, the server 1000 executes lottery processing of executing a lottery for a nurture game content or a support game content based on the lottery request information (S2).

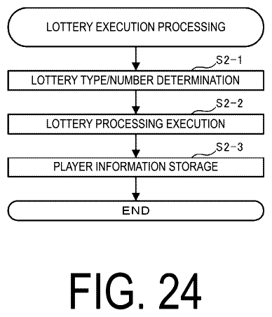

FIG. 24 is a flowchart for describing an example of lottery processing in the server 1000. When the lottery processing illustrated in FIG. 24 is started, the lottery control unit 802a determines the lottery type and the number of lotteries based on the lottery request information transmitted from the player terminal 1 (S2-1).

The lottery control unit 802a executes the lottery processing based on the determined lottery type and number of lotteries (S2-2). At this time, the lottery control unit 802a executes processing of subtracting or updating the amount of in-game currency or in-game items spent in the lottery processing from the amount of in-game currency or in-game items possessed by the player.

The lottery control unit 802a stores information related to the nurture game content ID or the support game content ID determined by the lottery processing and the amount of in-game currency or in-game items possessed by the player after subtraction processing in the player information storage unit 820 in association with the player ID (S2-3).

Returning to FIG. 23, the server 1000 sets the information related to the nurture game content ID or the support game content ID determined by the lottery processing as lottery result information indicating the lottery result of the lottery processing so that the player terminal 1 can receive the information.

Upon receiving the lottery result information, the player terminal 1 executes animation screen display processing of displaying an animation screen of the lottery animation on the display 26 (P3).

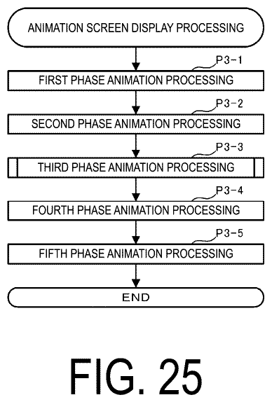

FIG. 25 is a flowchart for describing an example of the animation screen display processing P3 according to the present embodiment. As illustrated in FIG. 25, the virtual space generation unit 702a sequentially executes first phase animation processing (P3-1), second phase animation processing (P3-2), third phase animation processing (P3-3), fourth phase animation processing (P3-4), and fifth phase animation processing (P3-5).

As described in detail with reference to FIGS. 6 to 8, the first phase animation processing (P3-1) is processing of executing an animation performance in which the guide character 320 is caused to perform an action of opening the door 310 and inviting the player behind the door 310.

As described in detail with reference to FIGS. 9 and 10, the second phase animation processing (P3-2) is processing of executing an animation performance in which the viewpoint moves from the spectator seating 410 toward the gate 420.

As described in detail with reference to FIGS. 11 to 14, the third phase animation processing (P3-3) is processing of executing an enlarged animation in which the gate 420 and the silhouette character SC are displayed zoomed in. A detailed flow of the third phase animation processing will be described later.

As described in detail with reference to FIGS. 15 and 16, the fourth phase animation processing (P3-4) is processing of executing an animation performance in which the viewpoint is moved so that the silhouette characters SC arranged in the gate 420 are shown one by one in the horizontal direction through the gate 420.

As described in detail with reference to FIG. 17, the fifth phase animation processing (P3-5) is processing of executing an animation in which the exclusive silhouette character ESC is released from the gate 420 to remove the silhouette state and the lottery result character 482 is identified as the lottery result. The exclusive silhouette character model of the exclusive silhouette character ESC used in the fifth phase animation processing is different from the silhouette character model 424 of the silhouette character SC used in the third phase animation processing. Specifically, the exclusive silhouette character model used in the fifth phase animation processing is a black or gray exclusive silhouette character model simulating the lottery result character 482. On the other hand, the silhouette character model 424 used in the third phase animation processing is a common silhouette character model 424 used regardless of the lottery result.

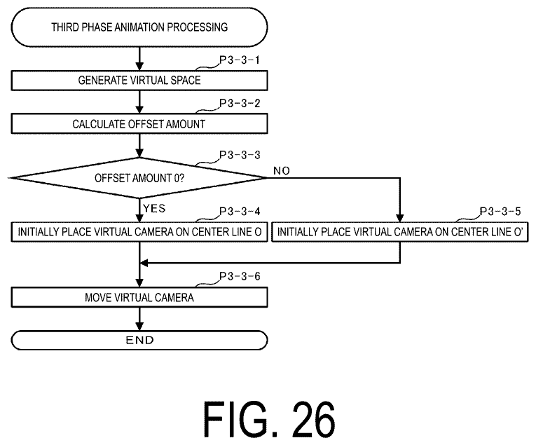

FIG. 26 is a flowchart for describing an example of the third phase animation processing P3-3 according to the present embodiment.

The virtual space generation unit 702a executes processing of generating the virtual space VS and arranging the 3D model and the virtual camera CA in the virtual space VS (P3-3-1). Here, as described with reference to FIG. 12, the virtual space generation unit 702a arranges a plurality of silhouette character models 424 in the arrangement spaces 426 according to a predetermined arrangement criterion based on the number of lotteries designated by the player.

The virtual camera control unit 704a calculates the offset amount with respect to the center line O which is the arrangement position of the virtual camera CA based on the number of lotteries designated by the player or the arrangement space 426 where the silhouette character models 424 are arranged (P3-3-2). When the number of lotteries designated by the player is the upper limit number of lotteries, the arrangement position of the virtual camera is arranged on the center line O. Thus, when the number of lotteries designated by the player is the upper limit number of lotteries, the offset amount with respect to the center line O is 0. Here, in the present embodiment, an example in which the upper limit number of lotteries of the game is set has been described, but the present invention is not limited thereto, and the upper limit number of lotteries of the game need not be set. In this case, the virtual camera CA is arranged to be aligned with the center line passing through the center position of the arrangement spaces 426 where the silhouette character models 424 provided in accordance with the number of lotteries are arranged.

The virtual camera control unit 704a determines whether the calculated offset amount is 0 (P3-3-3). When the offset amount is 0, the virtual camera control unit 704a arranges the virtual camera at the point P1′ on the center line O as the initial position of the virtual camera (P3-3-4). After that, the virtual camera control unit 704a controls the movement of the virtual camera CA along the center line O from the point P1′ to the point P2′ to the point P3′ so that the virtual camera CA approaches the gate model 422 (P3-3-6).

On the other hand, when the offset amount is not 0, the virtual camera control unit 704a arranges the virtual camera CA at the point P1 on the center line O′ offset from the center line O as the initial position of the virtual camera CA (P3-3-5). After that, the virtual camera control unit 704a controls the movement of the virtual camera CA along the center line O′ from the point P1 to the point P2 to the point P3 so that the virtual camera approaches the gate model 422 (P3-3-6).

In this manner, the arrangement position of the virtual camera CA arranged in the virtual space VS is controlled based on the calculated offset amount. In particular, when the number of lotteries designated by the player is less than the upper limit number of lotteries, the arrangement position of the virtual camera CA is changed to the position of the center line O′ offset from the center line O based on the number of lotteries or the arrangement spaces 426 where the silhouette character models 424 are arranged.

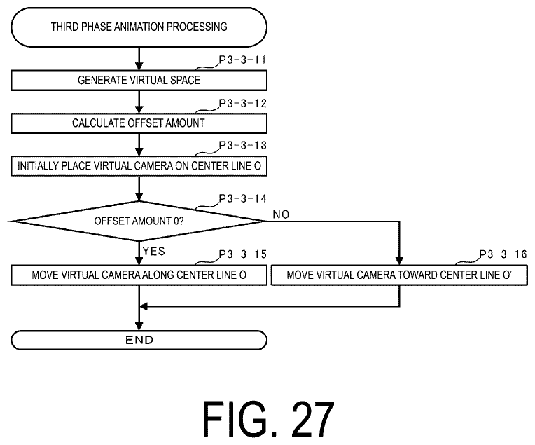

FIG. 27 is a flowchart for describing an example of the third phase animation processing P3-3 according to the first modified example.

The virtual space generation unit 702a executes processing of generating the virtual space VS and arranging the 3D model and the virtual camera CA in the virtual space VS (P3-3-11). Here, as described with reference to FIG. 13, the virtual space generation unit 702a arranges a plurality of silhouette character models 424 in the arrangement spaces 426 according to a predetermined arrangement criterion based on the number of lotteries designated by the player.

The virtual camera control unit 704a calculates the offset amount with respect to the center line O which is the arrangement position of the virtual camera CA based on the number of lotteries designated by the player or the arrangement space 426 where the silhouette character models 424 are arranged (P3-3-12).

The virtual camera control unit 704a arranges the virtual camera CA at the point P1′ on the center line O as the initial position of the virtual camera CA (P3-3-13). Then, the virtual camera control unit 704a determines whether the calculated offset amount is 0 (P3-3-14). In a case where the offset amount is 0, the virtual camera control unit 704a controls the movement of the virtual camera CA along the center line O from the point P1′ to the point P2′ to the point P3′ so that the virtual camera CA approaches the gate model 422 (P3-3-15).

On the other hand, when the offset amount is not 0, the virtual camera control unit 704a controls the movement of the virtual camera CA so that the virtual camera CA approaches the gate model 422 from the center line O toward the center line O′ (P3-3-16). Specifically, as illustrated in FIG. 13, when the number of lotteries designated by the player is less than the upper limit number of lotteries, the virtual camera control unit 704a arranges the virtual camera at a position of the point P1′ on the center line O. Thereafter, from the point P1′ to the point P2, the offset amount of the virtual camera CA is offset-controlled by the formula OV×((Tc−Ts)/(T1−Ts)). In this manner, the arrangement position of the virtual camera CA is controlled to be changed to the position of the center line O′ offset from the center line O. In this manner, the arrangement position of the virtual camera CA arranged in the virtual space VS is controlled based on the calculated offset amount.

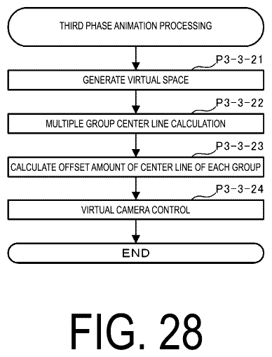

FIG. 28 is a flowchart for describing an example of the third phase animation processing P3-3 according to the second modified example.

The virtual space generation unit 702a executes processing of generating the virtual space VS and arranging the 3D model and the virtual camera in the virtual space VS (P3-3-21). Here, as described with reference to FIG. 14, the virtual space generation unit 702a arranges a plurality of silhouette character models 424 in the arrangement spaces 426 according to a predetermined arrangement criterion based on the number of lotteries designated by the player.

Specifically, in the example illustrated in FIG. 14, the virtual space generation unit 702a divides a plurality of the silhouette character models 424 arranged in the virtual space VS into the first group arranged in the first arrangement space 426a to the third arrangement space 426c, the second group arranged in the fourth arrangement space 426d to the sixth arrangement space 426f, and the third group arranged in the seventh arrangement space 426g.

The virtual space generation unit 702a arranges, according to a predetermined criterion, the first group so as to be aligned in a line in a direction from the first arrangement space 426a toward the third arrangement space 426c. Further, the virtual space generation unit 702a arranges, according to a predetermined criterion, the second group so as to be aligned in a line in a direction from the fourth arrangement space 426d toward the sixth arrangement space 426f. Further, the virtual space generation unit 702a arranges, according to a predetermined criterion, the third group so as to be aligned in a line in a direction from the seventh arrangement space 426g toward the tenth arrangement space 426j.

The virtual camera control unit 704a calculates the center lines O1, O2, and O3 passing through the center positions of the respective groups (P3-3-22). Then, the virtual camera control unit 704a calculates the offset amounts of the center lines O1, O2, and O3 of the respective groups with respect to the center line O (P3-3-23).

Then, the virtual camera control unit 704a controls the arrangement position of the virtual camera CA arranged in the virtual space VS based on the calculated offset amount (P3-3-24). Specifically, as described with reference to FIG. 14, the virtual camera control unit 704a performs control so as to arrange the virtual camera CA at the position of the point P1 on the center line O1 (that is, the center of the first group) offset from the center line O. After that, the virtual camera CA is controlled to be arranged at a position of the point P2 on the center line O2 (center of the second group) offset from the center line O. Thereafter, the virtual camera CA is controlled to be arranged at a position of the point P3 on the center line O3 (center of the third group) offset from the center line O.

Returning to FIG. 23, when the animation screen display processing ends, as illustrated in FIG. 18, the player terminal 1 executes lottery result screen display processing of displaying a lottery result screen indicating the lottery result of the lottery processing on the display 26 (P4).

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it should be understood that such modifications and corrections also obviously fall within the technical scope of the present invention.

In addition, the game screen described above is merely an example, and the game screen described using the drawings can be appropriately changed in design. In the above-described embodiment, an example has been described in which a 3DCG animation generated by virtually capturing 3D models arranged in the virtual space VS with the virtual camera CA is performed even in a phase not affected by the number of lotteries in a lottery animation. However, the present invention is not limited thereto, and in phases (the first phase and the second phase in the above-described embodiment) not affected by the number of lotteries in a lottery animation, the 3DCG animation may not be performed, and an animation video created in advance may be played as the animation. Thus, in a phase not affected by the number of lotteries in a lottery animation, the load of the CPU 10 of the player terminal 1 can be reduced, and the CPU 10 can be efficiently controlled. In addition, the present invention is not limited thereto, and in a phase not affected by the number of lotteries in the lottery animation, both the 3DCG performance and a performance of playing an animation video created in advance may be performed in combination. Thus, a richer lottery animation can be provided to the player.

Further, in the above-described embodiment, processing related to the lottery animation is executed in the player terminal 1. However, the processing related to the lottery animation may be executed in the server 1000 or may be executed by cooperation between the player terminal 1 and the server 1000.

In any case, it is only required that an information processing program causes one or more computers to execute the following processing.

### Processing Executed by Computer

Processing of receiving an operation from a player for designating any number of two or greater as the number of lotteries for a lottery object (in the embodiment, for example, P2).

Processing of arranging, according to a predetermined arrangement criterion, a plurality of common objects (in the embodiment, for example, the silhouette character models 424) being 3D models at lottery result arrangement positions (in the embodiment, for example, the arrangement spaces 426) in a virtual space VS based on the number of lotteries designated by the player.

Processing of changing an arrangement position of a virtual camera CA arranged in the virtual space VS based on the number of lotteries designated by the player or the lottery result arrangement positions where the plurality of common objects are arranged.

Further, in the above-described embodiment, an upper limit may be set for the number of lotteries designated by the player, and in the virtual space VS, a virtual arrangement frame (in the embodiment, for example, the gate model 422) including a plurality of the lottery result arrangement positions may be provided, and the plurality of common objects may be arranged at all of the plurality of lottery result arrangement positions in the virtual arrangement frame in a case where the number of lotteries is the upper limit.

The processing of changing the arrangement position of the virtual camera CA may include arranging the virtual camera CA to be aligned at a center position of the virtual arrangement frame, in a case where the number of lotteries is the upper limit, and arranging the virtual camera CA at an offset position offset from the center position based on the number of lotteries or the lottery result arrangement positions where the plurality of common objects are arranged, in a case where the number of lotteries is less than the upper limit.

Further, in the first modified example described above, the processing of changing the arrangement position of the virtual camera CA may include, in a case where the number of lotteries is less than the upper limit, arranging the virtual camera CA to be aligned at the center position of the virtual arrangement frame, and then arranging the virtual camera CA at the offset position offset from the center position.

Further, in the above-described second modified example, the predetermined arrangement criterion may include that the plurality of common objects arranged in the virtual space VS are divided into at least a first group and a second group, and each of the first group and the second group is arranged in a line in a predetermined direction at the lottery result arrangement position, and the processing of changing the arrangement position of the virtual camera may include arranging the virtual camera CA to be aligned at a center of the first group and a center of the second group.

In the above-described embodiment, the information processing program for realizing the game May be stored in a non-transitory computer-readable storage medium. In addition, the above-described embodiment may correspond to an information processing method for implementing each function and the steps illustrated in the flowcharts.

What is claimed is:

1. A non-transitory computer readable medium storing a program causing a computer to execute:
processing of receiving an operation from a player for designating any number of two or greater as the number of lotteries for a lottery object;
processing of arranging, according to a predetermined arrangement criterion, a plurality of common objects being 3D models at lottery result arrangement positions in a virtual space, based on the number of lotteries designated by the player; and
processing of changing an arrangement position of a virtual camera arranged in the virtual space, based on the number of lotteries designated by the player or the lottery result arrangement positions where the plurality of common objects are arranged.

2. The non-transitory computer readable medium according to claim 1, wherein
an upper limit is set for the number of lotteries designated by the player,
in the virtual space,
a virtual arrangement frame including a plurality of the lottery result arrangement positions is provided, and the plurality of common objects are arranged at all of the plurality of lottery result arrangement positions in the virtual arrangement frame in a case where the number of lotteries is the upper limit, and
the processing of changing the arrangement position of the virtual camera includes:
arranging the virtual camera to be aligned at a center position of the virtual arrangement frame, in a case where the number of lotteries is the upper limit; and
arranging the virtual camera at an offset position offset from the center position based on the number of lotteries or the lottery result arrangement positions where the plurality of common objects are arranged, in a case where the number of lotteries is less than the upper limit.

3. The non-transitory computer readable medium according to claim 2, wherein
the processing of changing the arrangement position of the virtual camera includes,
in a case where the number of lotteries is less than the upper limit, arranging the virtual camera to be aligned at the center position of the virtual arrangement frame, and then arranging the virtual camera at the offset position.

4. The non-transitory computer readable medium according to claim 1, wherein
the predetermined arrangement criterion includes that
the plurality of common objects arranged in the virtual space are divided into at least a first group and a second group, and the first group and the second group are arranged in a line in a predetermined direction at the lottery result arrangement positions, and
the processing of changing the arrangement position of the virtual camera includes
arranging the virtual camera to be aligned at a center of the first group and a center of the second group.

5. An information processing method executed by one or more computers, the information processing method comprising:
processing of receiving an operation from a player for designating any number of two or greater as the number of lotteries for a lottery object;
processing of arranging, according to a predetermined arrangement criterion, a plurality of common objects being 3D models at lottery result arrangement positions in a virtual space, based on the number of lotteries designated by the player; and
processing of changing an arrangement position of a virtual camera arranged in the virtual space, based on the number of lotteries designated by the player or the lottery result arrangement positions where the plurality of common objects are arranged.

6. An information processing system comprising one or more computers, wherein
the one or more computers execute:
processing of receiving an operation from a player for designating any number of two or greater as the number of lotteries for a lottery object;
processing of arranging, according to a predetermined arrangement criterion, a plurality of common objects being 3D models at lottery result arrangement positions in a virtual space, based on the number of lotteries designated by the player; and
processing of changing an arrangement position of a virtual camera arranged in the virtual space, based on the number of lotteries designated by the player or the lottery result arrangement positions where the plurality of common objects are arranged.
